(19) United States
(12) Patent Application Publication
(10) Pub. No.: US 2004/0035907 A1
(43) Pub. Date: Feb. 26, 2004

(54) Apparatus and method for dispensing solder

(76) Inventor: Stephanie Elisabeth Anna Radeck, Singapore (SG)

Correspondence Address: Laurence S Roach, Jaeckle Fleischmann & Mugel, Suite 200, 39 State Street, Rochester, NY, 14614-1310, US

(21) Appl. No.: 10/276,851

(22) PCT Filed: May 23, 2001
(86) PCT No.: PCT/SG01/00100

(30) Foreign Application Priority Data
May 24, 2000 (SG) 20002839-9

(51) Int. Cl. B23K 1/00

(52) U.S. Cl. 228/41; 228/247

(57) ABSTRACT

An apparatus for dispensing solder accurately onto a prescribed surface of a substrate including a feeding mechanism for dispensing the solid solder and a dispensing piece with a feeding channel. The positioning device has a front opening that is adapted for direct contact with the prescribed surface during the dispensing operation to form an enclosed cavity. The back opening couples the positioning device to the dispensing end of said dispensing piece such that during the dispensing operation the solder solid may be dispensed from the feeding channel through the cavity and onto the prescribed surface. The dispensing piece is maintained at a temperature below the melting temperature of the solder material such that the solder material stays in a solid state until it is in contact with the prescribed surface.

### FIELD OF THE INVENTION

The present invention relates to die bonding technology in the electronics industry. In particular, the present invention relates to soft solder wire dispenser and a method of using the same.

### BACKGROUND

Soft solder die bonding is a technique commonly used for die attachment onto a metallic leadframe. Prior art methods can be roughly divided into the solid dispensing method and the liquid dispensing method. In the solid dispensing method, a solid solder wire is advanced through a nozzle onto the heated surface of the leadframe. The direct contact with the heated surface causes the melting of the solder wire, whereupon a liquid solder dot is produced on the leadframe. The nozzle of the wire dispenser typically never touches the heated surface, which results in a gap, typically around 1-2 mm, between the nozzle and the position on the leadframe, onto which the solder is dispensed. The amount of wire to be dispensed is controlled by feeding the corresponding length of wire through the nozzle. However, due to the wetting interaction between the melting solder and the leadframe material (typically Copper with either bare Copper, Nickel, Silver or Palladium finish), the position of the solder dot has a tendency to deviate from the target position by as much as several millimeters from the contact point of the solder wire depending on the material combination. A certain amount of control may be exercised by the correct set-up of the wire dispenser such as the correct nozzle diameter and melting speed, but the major influencing parameter (i.e. the wetting property of the substrate material) cannot be readily controlled.

In U.S. Pat. No. 5,878,939, a positionally stable temperature transition is described by heating the solder material to the liquid state within the dispensing apparatus. The liquid solder is then injected into a mould cavity that restricts the surface wetted by the liquid solder. The melting of the solder material within the dispensing device, however, requires that suitable structures must be provided to retain the liquid material until dispensing commences. For this purpose, a capillary and a narrowing of the outlet is disclosed. This sophisticated design, however, requires precision manufacturing, increasing the cost of fabricating the device. Furthermore, sophisticated heating and cooling systems are needed to maintain the suitable temperatures required for the liquid dispensing device to function, further increasing costs.

### SUMMARY OF THE INVENTION

Accordingly, the present invention provides, in one aspect, an apparatus for dispensing solder accurately onto a prescribed surface of a substrate. The solder is dispensed directly from a solid wire or rod. The apparatus includes a dispensing piece provided with a feeding channel and controlled by a lowering mechanism. The feeding channel contains a receiving end through which the solid solder passes, and a dispensing end from which the solder solid is dispensed. The dispensing end directs the solid solder towards the prescribed surface, and has a positioning device fastened thereto.

The positioning device contains a front cavity connected to a back opening. The cavity has a front opening with an edge that is adapted for direct contact with the prescribed surface during the dispensing operation to form an enclosed cavity. The back opening couples the positioning device to the dispensing end of said dispensing piece such that during the dispensing operation the solder solid may be dispensed from the feeding channel through the cavity and onto the prescribed surface. The dispensing piece is maintained at a temperature below the melting temperature of the solder material such that the solder material stays in a solid state until it is in contact with the prescribed surface.

In another aspect, the method according to the present invention includes heating the substrate to a temperature at or higher than the melting temperature of the solder material. The tip of the solid solder wire or rod is then positioned directly above the prescribe surface on which the liquid solder dot is desired using the positioning device. The solder wire is then advanced until it establishes direct contact with the heated prescribed surface. The heat melts the solder wire and the liquid solder forms a dot at a predetermined area and predetermined position of the prescribed surface using the positioning device. The edge of the front opening and the cavity forms a sealed area above the prescribed surface. The volume of liquid solder is controlled by the distance of advancement of the wire. When the dispensing piece and positioning device are raised, the dot of a predetermined volume is undisturbed and remains at the predetermined position.

In the preferred embodiment, the aforementioned apparatus and method is applied to soft solder die bonding for attachment of a die onto a substrate, such as a leadframe for an integrated circuit (IC) chip in the electronics industry. In this process, the leadframe is heated in a furnace to a temperature above the melting temperature of the solder material. However, the solder wire itself is kept in a solid state until it is dispensed onto and in directed contact with the prescribed surface of the leadframe. An alignment system is provided to position the edge of the front opening of the positioning device onto the prescribed location. The tip of solid solder wire is then advanced until it is in direct contact with the leadframe, and melts into a liquid dot. The dot is again confined within the prescribed surface as sealed by the front opening of the cavity. The dispensing piece and the positioning device are then moved away without disturbing the dot. The die or chip is then placed directly onto the solder dot, before being cooled to bond with the leadframe. The advantage of this method is that the tooling requirements for the apparatus of the present invention are simple while positioning accuracy (which is the major prerequisite for improved die attachment quality) can still be achieved. Furthermore, the small surface area of a solder dot minimises sensitivity of the technique to the environment, such as exposure to the oxygen in the atmosphere that causes the formation of oxides, and interface with the leadframe that results in intermetallic phase growth.

### BRIEF DESCRIPTION OF THE DRAWINGS

FIG. 1 is a schematic drawing to show one embodiment of the present invention.

FIG. 2A shows the longitudinal cross-section of the dispensing piece connected to the alignment mechanism and the positioning device according to a preferred embodiment of the present invention.

FIG. 2B is the view of the cross-section of the same structure as FIG. 2A but along line B-B.

FIG. 2C is the longitudinal cross-sectional view of the dispensing piece according to the preferred embodiment. The traverse cross-section views of the receiving end (c44a), engagement region (c44c) and dispensing end (c44b) are also shown.

FIG. 2D is the cross-sectional view of the preferred embodiment along line A-A.

FIG. 2E is the exploded view of mounting bracket, alignment block, positioning device, device holder and the dispensing end of the dispensing piece in the preferred embodiment.

FIG. 3 is a schematic drawing of a soft solder dispensing system according to the present invention.

FIG. 4 is a schematic cross-sectional drawing of a dispensing and positioning apparatus according to another embodiment of the present invention.

FIGS. 5A is a longitudinal cross-section of a dispensing piece and positioning device according to a further embodiment of the present invention.

FIG. 5B is the sectional view of the same embodiment shown in FIG. 5A except that the cross section is taken along a longitudinal plane rotated 90 degrees from that at FIG. 5A.

FIGS. 6A and 6B show an enlarged view of the positioning device attached to the dispensing tool with the side wall in the fully extended and fully retracted positions respectively.

FIG. 7A shows a sectional view of a further embodiment of the present invention.

FIG. 7B is a sectional view along line W-W of the embodiment shown in FIG. 7A.

FIG. 7C is an enlarged view of the area shown in circle Y in FIG. 7A.

### DESCRIPTION OF THE INVENTION

In the following discussion, and in the claims the terms “including”, “having” and “comprising” are used in an open-ended fashion, and thus should be interpreted to mean “including but not limited to . . . ”. Substrate refers to any object on which the solder dot is applied. Specific examples include supporting structures in the electronic industry, such as metallic leadframes for IC devices.

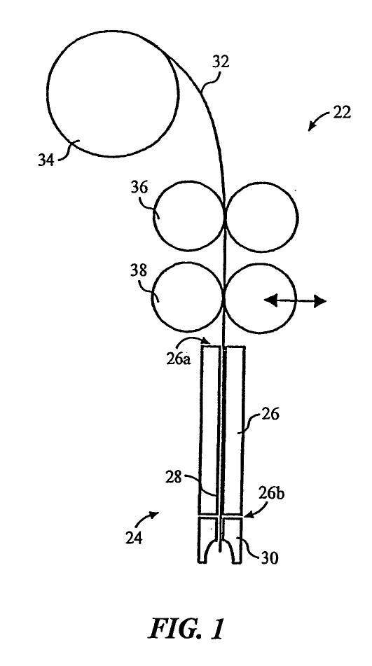

Referring first to FIG. 1, the present invention is provided with a feeding mechanism 22 and a dispensing mechanism 24. The dispensing mechanism includes a dispensing tool 26 and positioning tool 30. Dispensing tool 26 is preferably in the shape of an elongated nozzle with a channel 28 provided axially therein. It has a receiving end 26a and a dispensing end 26b. The positioning tool 30 is connected to the dispensing end 26b. A solder wire 32 from a spool 34 is threaded through the feeding mechanism into the receiving end of the dispensing tool. The feeding mechanism includes a set of advancing rollers 38 that are coupled to a motor (not shown), and a set of encoder rollers 36 coupled to an encoder (not shown).

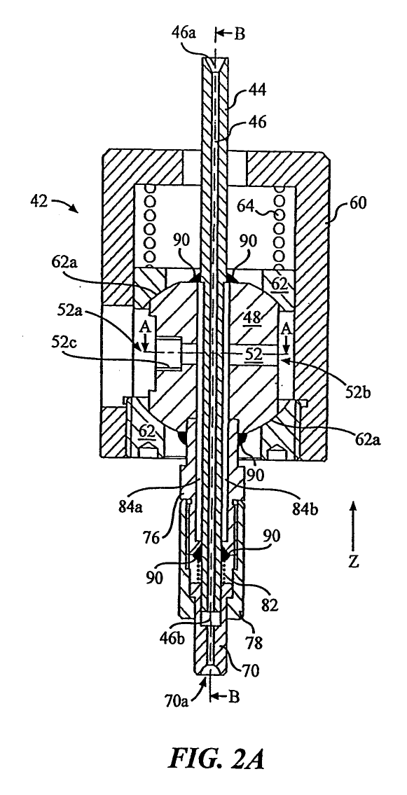

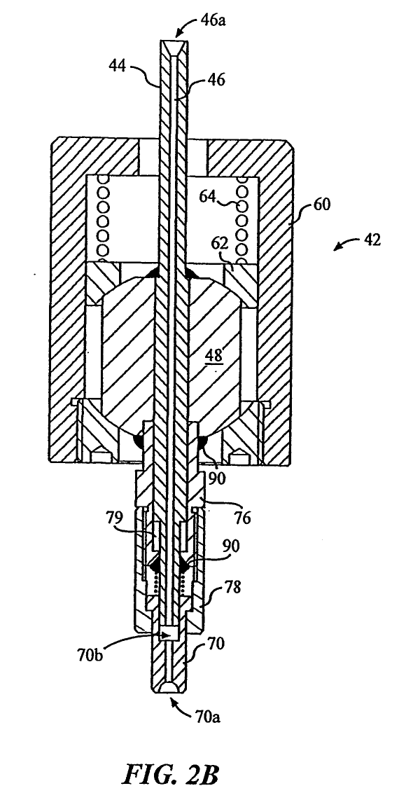

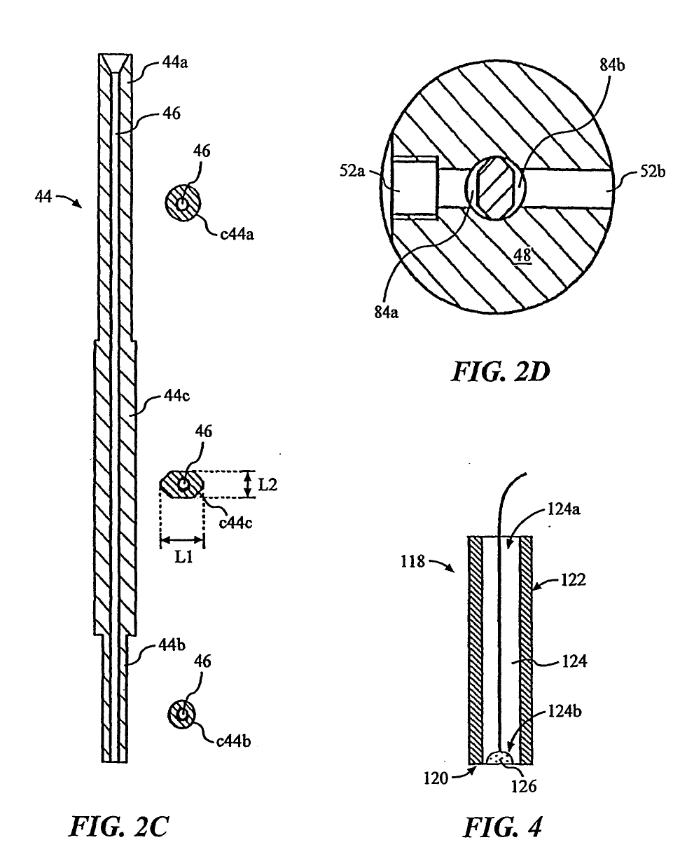

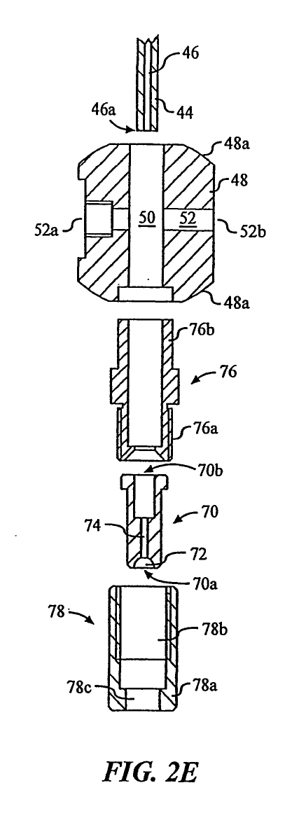

Referring now to FIGS. 2A to 2E, the specific preferred embodiment of the present invention includes an alignment mechanism 42 coupled to a dispensing piece 44. Dispensing piece 44 is an elongated rod containing an axially disposed narrow channel 46. It can be divided into the receiving end 44a, a dispensing end 44b and an engagement region 44c therebetween. In the preferred embodiment, the traverse cross-sectional shape of the receiving end c44a and the dispensing end c44b is cylindrical, while the shape of the engagement region c44c is non-cylindrical, with the length L1 of one axis longer than the length L2 of the perpendicular axis. L1 is also equal to the outer diameter of dispensing piece at the receiving end.

The alignment mechanism 42 includes an alignment block 48 coupled to a block holder 60. In the preferred embodiment shown, the alignment block 48 is a hexahedron with rounded comers 48a. A Z-axis channel 50, of a diameter equal to length L1, is provided for receiving the dispensing piece longitudinally therethrough. A cross channel 52, with an inlet 52a and an outlet 52b, is provided traversing the Z-axis channel 50. The inlet 52a includes a threaded collar 52c. The block holder 60 contains two separable halves that can be clamped tightly together and onto the alignment block 48 with screws or other mounting devices that can be used in order to automize the clamping. Block holder 60 also contains a set of braces 62 each having a smooth arcuate surface 62a facing the center of the holder. The smooth arcuate surfaces 62a are shaped to mate with the round corners of block holder 60 for sliding movement therebetween when the block holder is not tightly screwed onto the alignment block. When the screws are tightened, the braces 62 prevent further movement between the dispensing piece and the block holder.

Positioning device 70 contains a back opening 70b and a cavity 72 with a front opening 70a. In the specific preferred embodiment, the cavity 72 is connected to the back opening 70b (see FIG. 2E) by a connecting channel 74, and is rigidly mounted onto the dispensing end 46a of the dispensing piece using a mounting bracket 76 and a device holder 78. The cavity 72 is preferably half dome-shaped, with the front opening 70a having a flat circular shape.

The dispensing piece 44, alignment block 48 and mounting bracket 76 are permanently mounted together by brazing at positions shown by the solid black wedges 90. These welded joints are preferably airtight. Two narrow ventilation conduits 84a and 84b (see FIG. 2D) are created upon assembly. Inlet-conduit 84a is connected to the inlet side 52a of cross channel 52, while outlet-conduit 84b is connected to the outlet side 52b of cross-channel 52. Inlet-conduit 84a and outlet-conduit 84b are connected via a passage 79 created within the front end of the mounting bracket 76. This passage is created by the difference in cross-sectional shape between the engagement region and the dispensing region. The back end 78b of the device holder 78 is internally threaded while the front end 76a of the mounting bracket 76 has external threads to allow the device holder 78 to be mounted onto the mounting bracket. The front end 78a of the device holder also contains an opening 78c through which the positioning device 70 extends. An over-travel spring 82 is preferably inserted between the mounting bracket 76 and the positioning device during assembly. This design allows the positioning device to be conveniently detachable. As a result, it becomes possible for similar positioning devices, for example with different size cavities, to be readily exchanged such that different size solder dots for different applications may be readily produced with the same machine without further alterations.

Before the solder dispensing operation commences, an operator may adjust the alignment of the dispensing piece 44 and positioning device 70 such that the edge of the front opening 70a of the positioning device forms a solder liquid-seal with the substrate surface on which the solder is to be dispensed. This is performed by first tightening the positioning device onto the dispensing piece to form one rigid structure. The springs 64 pressing down the brace 62 on the alignment block are loosened, either manually or by an automated system. This allows the alignment block (i.e. including the dispensing piece and the positioning device) to move freely within the braces of the block holder 60. At the same time, the assembly is lowered onto the substrate such that the front opening 70a of the positioning device is flattened against the substrate surface. To maintain the positioning device at this angle throughout the remaining operation, the springs are then tightened again to prevent further movement of the alignment block.

A solder liquid-seal refers to a close proximity between the front opening of the positioning device and the prescribed surface such that in the brief period during which the solder is melted and formed into the desired volume within the cavity, minimal bleed out of the liquid solder occurs, and a solder dot of a predetermined volume at the predetermined positioned is formed when the positioning device is removed. The gap between the edge of the front opening and the prescribed surface is dependent, among other parameters, on the wetting properties of the interior surface of the cavity, the prescribed surface and the solder material. As a non-limiting example, a gap of 5-10 μm may be present for a lead solder dot forming on a copper surface, while still maintain a solder liquid seal within the cavity.

During operation, a solder wire (not shown for ease of illustration) is fed into the channel 46 of the dispensing piece 44. The solder wire is kept at a temperature below its melting temperature by cooling gas that is pumped into the apparatus through inlet 52a. The cooling gas is forced through the inlet side 52a of cross-channel 52. This cooling gas travels downwards along inlet conduit 84a towards the dispensing end of the dispensing piece 44. The gas is then forced through space 79 and into outlet conduit 84b, where it travels upwards and is released via the outlet 52b of cross channel 52.

The positioning device is lowered onto the prescribed position on a heated substrate such that the flat circular edge of front opening 70a forms a solder liquid seal with the flat surface of the substrate. The over-travel-spring 82 allows the positioning device to be resiliently and tightly abutted onto the prescribed surface without scratches or damages. The tip of the solder wire is then advanced through connecting channel 74 of the positioning device into the cavity 72 and finally coming into direct contact with the substrate surface. Heat from the substrate is conducted to the wire tip and causes the solder wire to melt, creating a droplet or dot of liquid solder. The total required amount of wire is then transported down onto the substrate by the feeding mechanism. The melted liquid solder is confined within the cavity 72 of the dispensing tool, and once sufficient solder has been melted, the wire and the positioning tool is lifted up without disturbing the position of the dot. Thus, the position and volume of the dot of liquid solder is controlled.

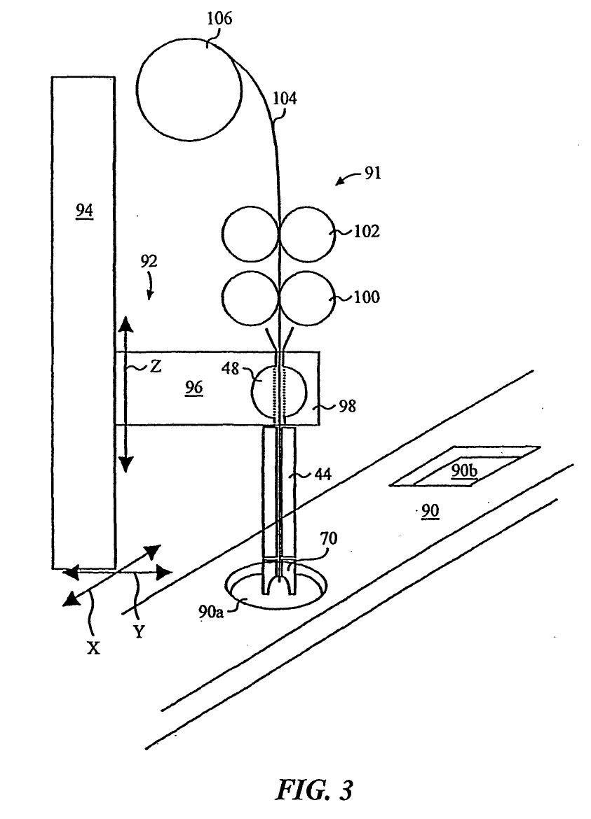

FIG. 3 shows how the present invention is applied to the dispensing of soft solder onto leadframes for IC devices or dice, for example, the dispensing of lead rich solder onto bare copper leadframes. In this embodiment, a furnace 90 with a soft solder dispensing position 90a, a bonding position 90b and indexing capability is provided below the dispensing station 92. This station has a supporting stand 94. A dispensing arm 96 is slidably mounted onto supporting stand 94 for movement in the Z-direction. Manual adjustment of the position of the positioning device 70 relative to the substrate is also possible in the X and Y directions by a X-Y micrometer table provided below the supporting stand 94. Both axis can be motorized in order to handle matrix applications and/or multichip applications, where an automized X/Y movement of the module may be necessary in order to reach the different dispensing positions. The dispensing apparatus, including the dispensing piece 44, the alignment block 48 and the positioning device 70, are mounted onto the dispensing arm 96 using a pair of clamps 98. The feeding mechanism 91 includes a motor with rollers 100, an encoder 102 and a sensor for detecting the presence of the wire, (not shown). The feeding mechanism 91 interacts with the solder wire 104 on the solder spool 106 to cause wire dispensing.

As in the previous embodiment, the apparatus is first aligned such that the positioning device can form a solder liquid seal with the substrate below. The operator then tightens the mounting means between the dispensing arm 96 and the alignment block 48, either manually or by using the corresponding software and control system. The solder wire 104 is fed between the motor rollers 100 and is advanced as the rollers roll forward. The encoder 102 checks the actual distance advance by the wire. This generates a closed loop regulation mechanism for feeding the correct amount of solder. The sensor is used to detect the presence of the wire, which is used by the software to enable a completely automated feeding procedure. The leadframes are transported into the furnace 90 and indexed towards the dispensing position 90a. The positioning device 70 is then lowered onto the prescribed surface to form a liquid tight seal. The wire is then advanced until direct contact is made with the heated leadframe and the correct amount of wire has been transported down, thus forming a liquid solder dot within the cavity of the positioning device. The dispensing apparatus is then raised and the leadframe indexed forward to the next position. When the leadframe reaches the bonding position, one die is place on each solder dot. Due to the ability of the present machine to position each solder dot accurately, it becomes possible to place the die precisely on top of the solder dot without the need for sophisticated vision and position control. As a result, the present method produces solder bonds that have lower skewness of the die attach layer (die tilt) compared to those produced by standard wire dispensing techniques.

In an alternative embodiment of the present invention as shown in FIG. 4, the dispensing piece and the positioning device form a single piece. This single piece dispensing and positioning apparatus may be as simple as a cylinder 118 with a dispensing end 120 that is adapted to form a solder liquid seal with the prescribed surface, as shown in FIG. 4. In this embodiment, the dispensing piece is the receiving end 122 of the cylinder, and the positioning device is the dispensing end 120 of the cylinder. The dispensing channel 124 has an enlarged internal diameter that extends all the way down to the dispensing end of the cylinder. Thus, the receiving end 124a of channel 124 is equivalent to channel 46 shown in FIG. 2C, while the dispensing end 124b of channel 124 is equivalent to cavity 72a in FIG. 2E. In FIG. 4, a solder dot 126 is also shown to illustrate how this embodiment may be operated.

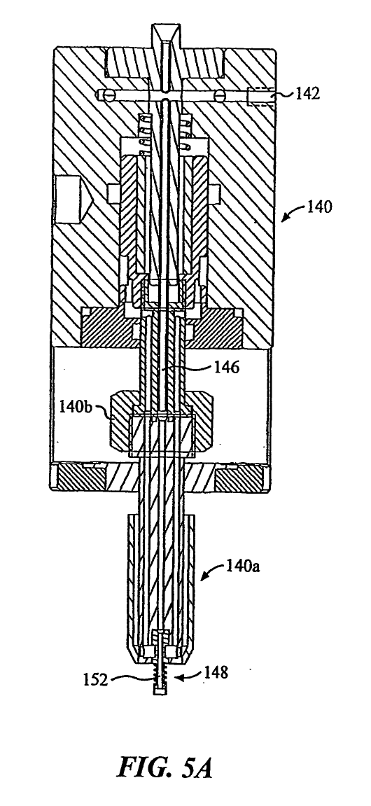

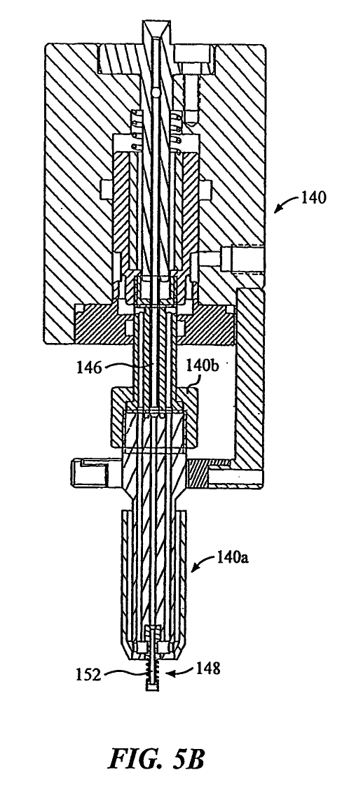

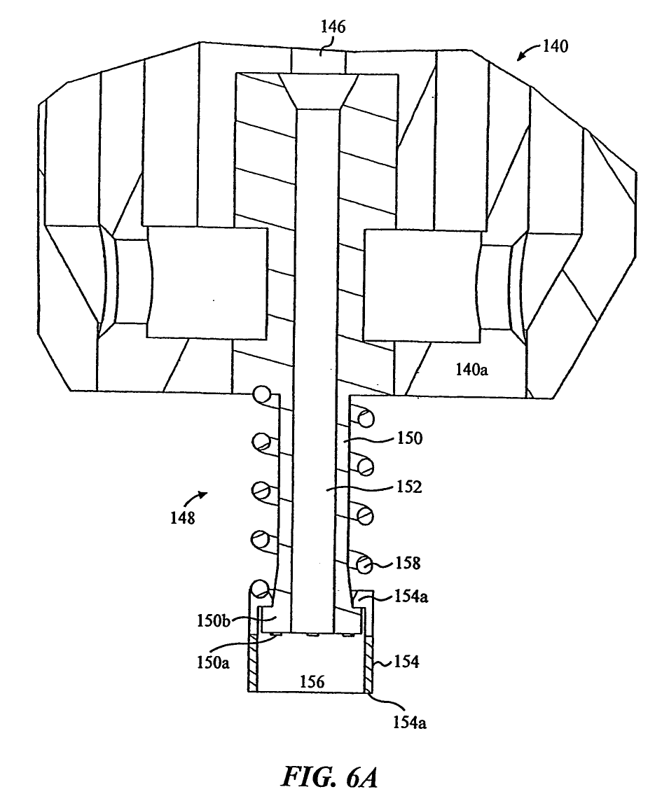

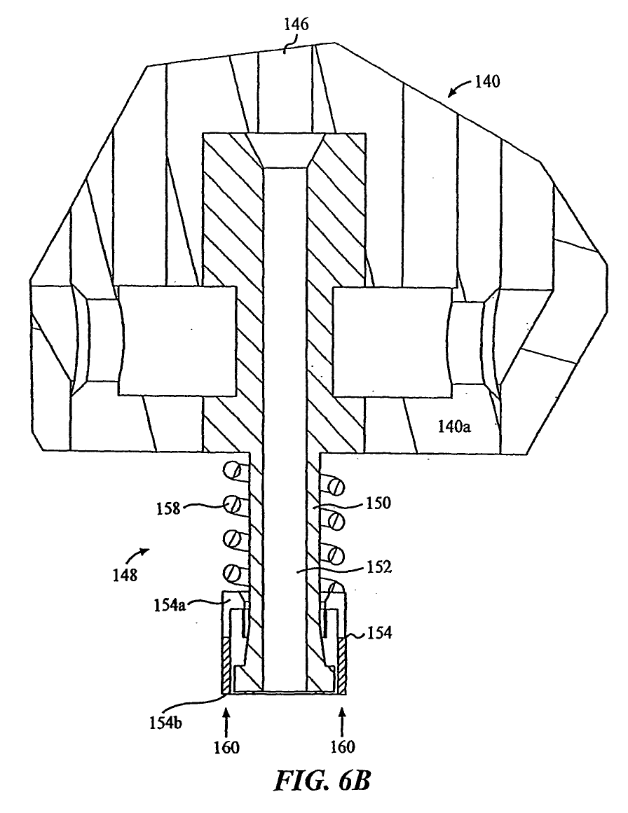

Referring now to FIGS. 5A and 5B, a further embodiment of the present invention contains a positioning device that is provided with a self-alignment mechanism such that pre-operation alignment as described in the previous embodiments is rendered unnecessary. In this embodiment, the dispensing piece 140 is provided with a gas ventilation system having an inlet 142 and outlet (not shown), and channel 146 wherethrough solid solder is dispensed. Referring also to FIGS. 6A and 6B, the positioning device 148 is attached to dispensing piece 140. The connection element in the dispensing piece is in the form of a short nozzle 150 having a axial channel 152 connecting to channel 146 of the dispensing piece. In this embodiment, the short nozzle 150 is permanently coupled to the lower section 140a of the dispensing piece. The lower section 140a of the dispensing piece 140 is screwed onto the upper section by nuts 140b for convenient exchange of different positioning devices.

Referring again to FIGS. 6A and 6B, a side wall 154 is provided in the positioning device 148 for interaction with the short nozzle 150 to define a cavity 156 therein. The side wall is provided with a flange 154a on one end (referred to as the engaging end), and a straight edge 154b at the other end (referred to as the sealing end). A coil spring 158 is mounted co-axially on the exterior of the short nozzle 150 and exerts a downwardpushing force on the side wall. Flange 154a maintains engagement of the side wall with the short nozzle. In the absence of any compressional force, the spring 158 maintains the side wall in the fully extended position. During the dispensing operation, the lowering mechanism lowers the apparatus onto the leadframe. As the edge 154b of the side wall is pressed against the leadframe, a compressional force (shown by arrows 160 in FIG. 6B) pushes against spring 158, causing the side wall the become retracted. The amount of retraction at different sections of the side wall would depend on the alignment of the side wall relative to the leadframe. Thus, even if the positioning device contacts the leadframe at an inclined angle, the section of the side wall that comes into contact with the leadframe first will automatically cause a pivoting movement of the entire side wall until good alignment is achieved.

Furthermore, depending on the distance of the downward movement, this would reduce the height of cavity 156 accordingly. In the preferred embodiment, the end of nozzle 150 is enlarged to form a spanking surface 160b with spacers 150a extending thereunder. The spanking surface may be used to provide an additional and optional stamping function. In this method, the solder dot is first dispensed onto the prescribed surface of the leadframe and within the enclosure created by cavity 156. The height of the cavity is defined by the side wall being in the fully or partially extended position. The positioning device is then pressed further down such that the side walls are further retracted, and the spanking surface of the nozzle presses onto the liquid solder dot inside the enclosed cavity, causing the liquid solder to form a solder pattern. The spacers 150a may be provided to create a minimum height for the cavity (i.e. desired pattern height).

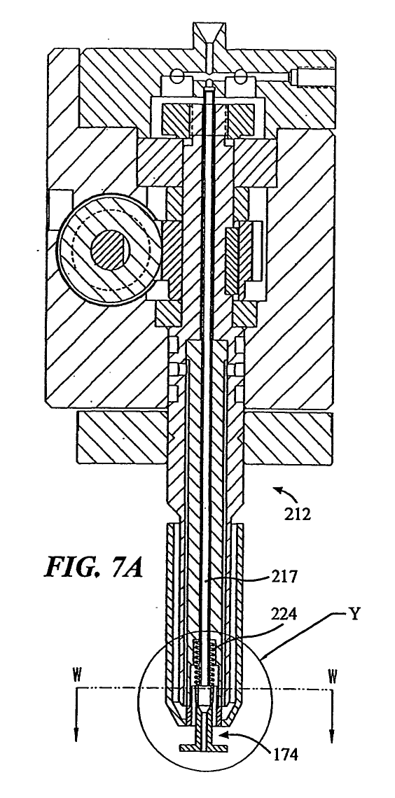

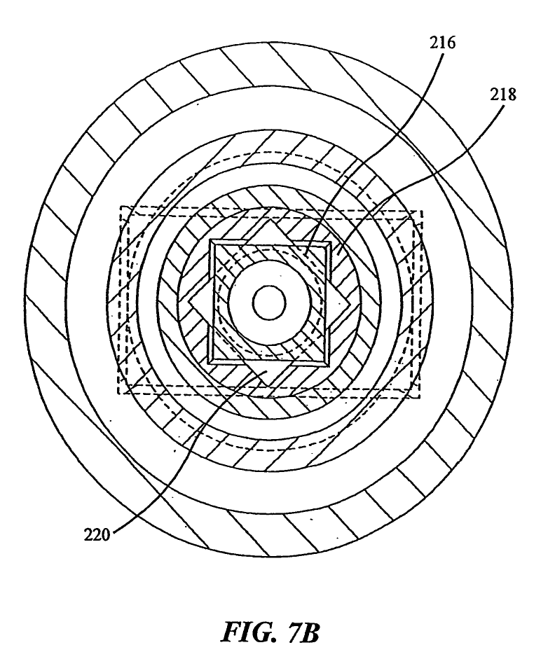

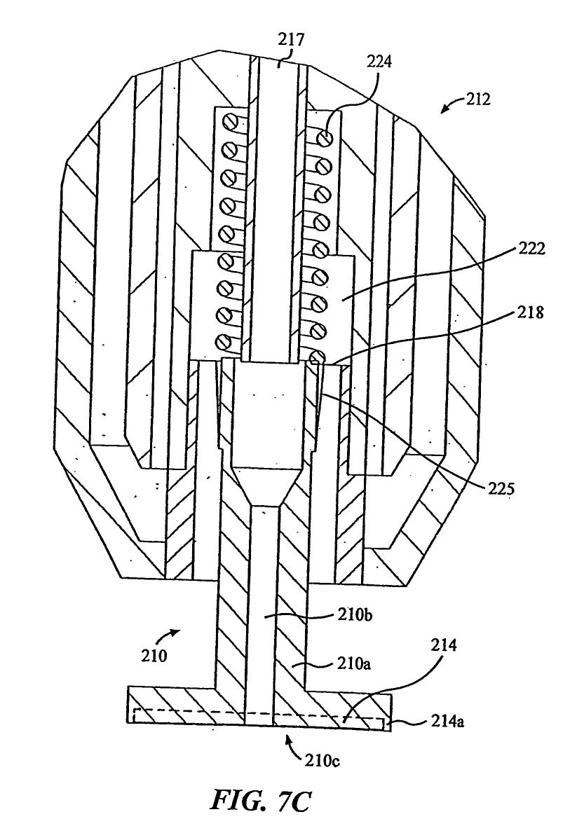

FIGS. 7A-7C shows a further embodiment of the present invention. In this embodiment, not only is the position of the solder liquid pre-determined, but the shape can also be pre-defined. The channel 217 of the dispenser 212 is provided with a self-aligning dispensing tool 210. The dispensing tool 210 is attached to the tip of your dispenser 212 for shaping the liquid solder. The dispenser is provided with cooling means that maintains the solid solder wire in a solid state until melting occurs upon contact with the heated substrate surface. The shaping of the solder liquid is accomplished by an enclosure 214 at the dispensing end of the tool that restricts the flow of the melted solder. (In the drawing show in FIG. 7B, the enclosure is shown by the dotted lines and appears to be relatively large. This is for ease of illustration, and it should be appreciated that the height of the enclosure is flexible, and may be determined according to the need of the user). The enclosure contains a sidewall 214a that is adapted to minimize bleeding of the solder to the exterior. The top of the dispensing tool has a nozzle 210a with a conduit 210b provided axially therein. Lugs 216 are provided at the upper end of the tool, while the channel 217 in the dispenser has a flange 218 with notches 220 that match the lugs, such that the tool may be reversibly mountable onto the dispenser by a simple insert-and-twist mechanism. Thus, the tool simply “hangs” on the flange. Ample space 222 is provided above the flange to allow upward movement of the tool relative to the flange in the presence of a upward force. A spring 224 is used to press the lugs against the flange. The wall of the channel is designed to have a slight outward inclination 225 relative to the vertical axis (i.e. the diameter of the inner wall of the channel is slightly larger than the diameter of the outer wall of the tool), such that the tool hangs freely from the flange. Hence there is no frictional engagement between the tool and the wall of the channel during the dispensing process as the tool is being keep in a vertical position on the substrate by the spring 224. The solder wire is kept cool and in a solid state until in is in direct contact with the substrate surface.

During the dispensing process, the solid solder wire is fed through channel 217 of the dispenser and channel 210b of the tool. During the downward stroke of the dispensing action, the dispensing end 210c is lowered onto the substrate. An over-travel action is used to ensure that the dispensing edge of the enclosure is properly aligned and parallel to the surface of the substrate. The inclined channel walls 225 of the dispenser allows sufficient space for the tool to tilt in any direction for proper alignment. The spring 224 further provides the freedom of movement, including the axial movement for the tool. Once proper alignment is achieved via the over-travel action, the solder wire is advanced until it is in direct contact with the surface of the heated substrate.

While the present invention has been described particularly with references to FIGS. 1 to 7C with emphasis on a system for soft solder die bonding for IC devices, it should be understood that the figures are for illustration only and should not be taken as limitation on the invention. In addition it is clear that the method and apparatus of the present invention has utility in many applications where dispensing of material is used. It is contemplated that many changes and modifications may be made by one of ordinary skill in the art without departing from the spirit and the scope of the invention described.

The alignment mechanisms described above are mechanical solutions that are useful for low-cost machines. It is clear that other mechanical or electronic methods of alignment may also be used to ensure a liquid tight seal between the cavity of the positioning tool and the prescribed surface of the substrate. Furthermore, the cooling means described in the preferred embodiment utilizes cooling air or gas dispensed through a series of conduits and channels created by the differing shapes of the various elements. It is clear that other cooling methods may be employed. If a suitable heat-dissipating material is used in the present invention, the cooling mechanism may be the material property itself. As another example, a heating pipe with a heat conducting liquid sealed therein may be used to provide cooling. The internal surface of the cavity is preferably made of a material that is not wettable with the solder material, for example, titanium or titanium alloy. The cavity is designed to restrict the area on the leadframe on which the solder can wet. The ideal diameter of the cavity is at least the size of the naturally wetted area, and this depends on the materials and the size of the dot. The height of the cavity during the dispensing step is most preferably greater than the height of the solder dot that is eventually produced. Different positioning devices with different size and shape cavities may be provided to suit a wide range of dot sizes. E.g. cavities may be dome or quadrilateral in shape. Furthermore the side wall may have a perimeter of any desired shape, such as rectangles or circles. The simple way the positioning device is attached to the dispensing piece in the preferred embodiment described in FIGS. 2A-2E allows for quick and convenient exchanges without changing the entire dispensing mechanism. Other equivalent structures include, but are not limited to, having the dispensing mechanism and positioning device as unconnected pieces, with the positioning of each piece being performed separately. For example, the solder dispensing apparatus can be operated with two sets of clamps or arms, with one arm controlling the positioning of the positioning device and the other arm controlling the positioning of the dispensing mechanism.

1. An apparatus for dispensing solder in the form of wire or rod onto a substrate comprising:
a lowering mechanism for moving said apparatus between a raised standby-position and a lowered dispensing position;
a dispensing-piece having a feeding channel wherethrough said solder solid passes, said feeding channel having a receiving end for receiving said solid solder therethrough, and a dispensing end for directing said solder solid towards a prescribed surface of said substrate, said dispensing piece further being maintained at a temperature below the melting temperature of said solder solid; and
a positioning device comprising a front cavity connected to a back opening,
said cavity having a front opening, the edge of said front opening adapted for direct contact with said prescribed surface to form an enclosed cavity when said apparatus is in the dispensing position; and
said back opening connected to said dispensing end of said dispensing piece such that during the dispensing operation said solder solid may be dispensed through said cavity and onto said prescribed surface.

2. An apparatus according to claim 1 wherein said positioning device further comprises
a connecting element having a channel for communication between a distal end and a proximal end, said proximal end containing said back opening and mounted onto said dispensing piece such that said solder solid can pass from said distal end to said proximal end; and
a side wall slidably engaging the distal end of said connecting element to define said cavity therein; and
a holding mechanism, engaging said side wall, for providing a pivot movement to said side wall such that a solder liquid-tight seal is formed when said apparatus is lowered to the dispensing position.

3. An apparatus according to claim 2 wherein said side wall is further movable between an extended position and a retracted position such that the height of said cavity in said extended position is larger than the height of said cavity in said retracted position.

4. An apparatus according to any one of the above claims wherein the front opening of said cavity has diameter larger or equal to the natural diameter of said liquid solder dot.

5. An apparatus according to claim 1 wherein said positioning device is exchangeable.

6. An apparatus according to claim 1 wherein said dispensing piece and said positioning device form a single piece.

7. An apparatus according to claim 1 wherein said positioning device is rigidly coupled to said dispensing piece, and said apparatus further comprises an alignment mechanism coupled to said dispensing piece for maintaining the position of said positioning device at an angle that allows said front opening to form a solder liquid-tight seal with said prescribed surface during the dispensing operation.

8. An apparatus according to claim 1 further comprising a cooling mechanism for cooling said solder material within said feeding channel to a temperature below the melting point.

9. An apparatus according to claim 1 wherein said positioning device is provided with lugs and said feeding channel of said dispensing piece is provided with a flange, said flange having notches that match said lugs such that said positioning device may be inserted into said channel with said lugs inserted through said notches such that said positioning device can hang from said flange.

10. An apparatus according to claim 9 further comprising a spring provided in said channel of said dispensing piece for providing a downward tension on said lugs.

11. An apparatus according to claim 10 wherein said channel of said dispensing device is provided with sufficient space to allow said tool a measure of movement in all directions.

12. A method of controlling the positioning a liquid solder dot in soft solder dispensing with solder wire comprising:
providing a substrate with a prescribed surface on which said liquid solder dot is to be placed;
heating said substrate to a temperature above the melting temperature of said solder material;
positioning a positioning device at a predetermined position on said prescribed surface, said positioning device with a cavity forming a solder-liquid tight seal with said prescribed surface;
advancing said solid solder wire through said cavity until said solder wire makes direct contact with said prescribed surface at said predetermined position and the end of said solder wire melts into a liquid state; and
withdrawing the unmelted solid solder wire to produce a liquid solder dot of a predetermined volume at said predetermined position.

13. A method of soft solder die bonding for attachment of a die onto a leadframe comprising:
providing a prescribed surface on said leadframe whereon said liquid solder dot is to be placed;
heating said leadframe to a temperature above the melting temperature of said solder material;
positioning a solid solder wire or rod directly above said prescribed surface using a positioning devices placed at a predetermined position on said prescribed surface, said positioning device having a cavity forming a solder liquid-tight seal with said prescribed surface;
advancing said solid solder wire through said cavity until direct contact with said prescribed surface is made and the end of said solder wire melts into a liquid state;
producing a liquid solder dot of a predetermined volume at said predetermined position on said prescribed surface and within said cavity of said positioning device;
moving said positioning device and said dispensing piece away from said prescribed surface without disturbing the position of said solder dot;
placing a die on said solder dot; and
cooling said leadframe to form a solder connection between said die and said leadframe.
